(19) United States
(12) Patent Application Publication
(10) Pub. No.: US 2020/0143362 A1
(43) Pub. Date: May 7, 2020

(54) METHOD AND SYSTEM FOR ISSUING SUPPLEMENTARY CARDS

(71) Applicant: Mastercard International Incorporated, Purchase, NY (US)

(72) Inventors: Manu D K, Mumbai (IN); Saket Bhardwaj, Mumbai (IN); Akshat Pathak, Gurgaon (IN)

(21) Appl. No.: 16/587,874

(22) Filed: Sep. 30, 2019

(30) Foreign Application Priority Data
Nov. 5, 2018 (SG) 10201809803V

(51) Int. Cl. G06Q 20/34; G06Q 20/22; G06Q 20/36

(52) U.S. Cl. CPC G06Q 20/3578; G06Q 20/3672; G06Q 20/351; G06Q 20/227

(57) ABSTRACT

A method for issuing supplementary cards includes a first request received by a server for issuing a virtual supplementary card in real time to a beneficiary. The virtual supplementary card is to be linked to a primary card of a primary card holder. The first request includes information of the beneficiary and is initiated by the primary card holder from a first digital account created on a first application. The server validates the information of the beneficiary and generates the virtual supplementary card in real time. The server provides the virtual supplementary card to the beneficiary. The virtual supplementary card is accessible to the beneficiary by way of a second digital account for performing one or more transactions.

### CROSS-REFERENCE TO RELATED APPLICATION

This application is a U.S. National Stage filing under 35 U.S.C. § 119, based on and claiming benefits of and priority to Singapore Patent Application No. 10201809803V filed on Nov. 5, 2018. The entire disclosure of the above application is incorporated herein by reference for all purposes.

### FIELD OF THE INVENTION

The present invention relates to a method and a system for issuing transaction cards, and, more particularly to a method and a system for issuing a supplementary card in real time.

### BACKGROUND

Digitization has led to an emergence of payment platforms that enable users to perform hassle free financial transactions. Examples of such payment platforms include automated teller machines (ATMs), point-of-sale (POS) devices, online payment gateways, or the like. Typically, these payment platforms require a payment account, a transaction card, or an application for performing the financial transactions. In one example, a user, who has to withdraw cash from her payment account at an ATM, either requires a transaction card which is linked to the payment account or a unique identifier, such as a registered contact number, linked to the payment account. In another example, a user, who has purchased a product from a merchant store, requires cash that is equivalent to the price of the product, a transaction card linked to her payment account, or a smartphone having a wallet application installed therein to pay for the product.

Every payment account and wallet has a primary account holder, who is authorized to perform financial transactions from her corresponding payment account or the wallet. In a scenario, when a family member of the primary account holder has to perform a financial transaction from the payment account of the primary account holder, the primary account holder has to give her transaction card or the smartphone hosting the wallet application to the family member for performing the financial transaction. However, under certain circumstances it becomes difficult for the primary account holder to provide her transaction card or the smartphone to the family member, which may cause inconvenience to both the family member and the primary account holder.

A known solution to the above-mentioned problem includes sharing a password linked to the wallet application with the family member. However, the possibility of the password getting compromised increases when more people know the shared password, thereby posing a threat of fraudulent financial transactions from the wallet of the primary account holder. Another known solution includes applying for a supplementary card that is linked to the primary card of the primary account holder for a beneficiary, such as the family member. The beneficiary generally receives the supplementary card within 5-7 business days after the primary account holder requests an issuer to issue the supplementary card. The supplementary card received by the beneficiary has to be activated in order to perform financial transactions. The beneficiary is unable to perform financial transactions until the supplementary card is received and activated, which may be a cause of concern, particularly in case of emergency.

In light of the foregoing, there exists a need for a solution that overcomes the abovementioned problems and allows an issuer to issue a supplementary card to a beneficiary in real time.

### SUMMARY

In an embodiment of the present invention, a method for issuing a supplementary card is provided. The method includes a first request, received by a server, for issuing a virtual supplementary card in real time to a beneficiary. The virtual supplementary card is to be linked to a primary card of a primary card holder. The first request includes information of the beneficiary and is initiated by the primary card holder from a first digital account created on a first application. The information of the beneficiary is validated by the server based on the first request. The virtual supplementary card is generated by the server, in real time, in response to a successful validation of the information of the beneficiary. The virtual supplementary card is provided by the server to the beneficiary based on the information of the beneficiary. The virtual supplementary card is accessible to the beneficiary by way of a second digital account for performing one or more transactions.

In another embodiment, a system for issuing a supplementary card is provided. The system comprises an issuer server that is configured to receive a first request for issuing a virtual supplementary card in real time to a beneficiary. The virtual supplementary card is to be linked to a primary card of a primary card holder. The first request includes information of the beneficiary and is initiated by the primary card holder from a first digital account created on a first application. The issuer server validates the information of the beneficiary based on the first request and generates the virtual supplementary card in real time in response to a successful validation of the information of the beneficiary. The issuer server provides the virtual supplementary card to the beneficiary based on the information of the beneficiary such that the virtual supplementary card is accessible to the beneficiary by way of a second digital account for performing one or more transactions.

In yet another embodiment of the present invention, a method for procuring a supplementary card is provided. The method includes creating a first digital account of a primary card holder by a first application hosted by a server. The first application renders a user interface that presents the first digital account to the primary card holder. The user interface includes a first option for issuing a virtual supplementary card linked to a primary card of the primary card holder in real time. Further, when the primary card holder selects the first option, the first application prompts the primary card holder to provide information of a beneficiary of the virtual supplementary card. When the primary card holder submits the information of the beneficiary, the first application communicates a first request to an issuer of the primary card. The issuer generates the virtual supplementary card and provides the virtual supplementary card to the beneficiary in real time based on the first request. The virtual supplementary card is accessible to the beneficiary by way of a second digital account for performing one or more transactions.

### BRIEF DESCRIPTION OF THE DRAWINGS

Various embodiments of the present invention are illustrated by way of example, and not limited by the appended figures, in which like references indicate similar elements, and in which:

FIG. 1 is a block diagram that illustrates an exemplary environment in which various embodiments of the present invention are practiced;

FIG. 2 is a process flow diagram that illustrates creation of a digital account of a user, in accordance with an embodiment of the present invention;

FIG. 3 is a process flow diagram that illustrates addition of a transaction card to a digital account of a user, in accordance with an embodiment of the present invention;

FIGS. 4A-4C represent process flow diagrams that illustrate an exemplary scenario where a virtual supplementary card is issued to a beneficiary in real time based on a request of a primary card holder, in accordance with an embodiment of the present invention;

FIG. 5 is a block diagram that illustrates the first application server, in accordance with an embodiment of the present invention;

FIG. 6 is a block diagram that illustrates the payment network server, in accordance with an embodiment of the present invention;

FIG. 7 is a block diagram that illustrates the issuer server, in accordance with an embodiment of the present invention;

FIGS. 8A-8C represent an exemplary scenario that illustrates a UI of the first application, in accordance with an embodiment of the present invention;

FIG. 9 is a flow chart that illustrates a method for procuring a virtual supplementary card for a beneficiary, in accordance with an embodiment of the present invention;

FIGS. 10A and 10B, collectively represent a flow chart that illustrates a method for issuing the virtual supplementary card to a beneficiary, in accordance with an embodiment of the present invention;

FIG. 11 represents a high-level flow chart that illustrates a method for issuing a supplementary card, in accordance with another embodiment of the present invention;

FIG. 12 represents a high-level flow chart that illustrates a method for procuring a supplementary card, in accordance with an embodiment of the present invention; and

FIG. 13 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

An issuer issues a primary card to an account holder of a payment account, thereby enabling her to perform transactions from the payment account. The account holder, who is the primary card holder of the primary card, usually applies for a supplementary card linked to the primary card for a beneficiary. It typically takes 5-7 business for the beneficiary to receive the supplementary card. The supplementary card received by the beneficiary is initially inactive for security reasons and has to be activated for performing transactions. As a result, the beneficiary is unable to perform the transactions until the supplementary card is activated, which may cause inconvenience to the beneficiary in case of an emergency.

Various embodiments of the present invention provide a method and a system that solve the abovementioned problems by allowing issuers to issue supplementary cards to beneficiaries in real time. A primary card holder of a primary card accesses a first application on a first device and creates a first digital account on the first application. The primary card holder accesses the first digital account through a user interface (UI) rendered by the first application on the first device. The UI presents a first option to the primary card holder for issuing a virtual supplementary card that is linked to the primary card. When the primary card holder wishes to procure a supplementary card that is linked to the primary card, the primary card holder selects the first option. On the selection of the first option, the UI prompts the primary card holder to submit details of a beneficiary, such as an identifier of a second digital account of the beneficiary. The primary card holder submits the details of the beneficiary and the first application communicates a first request to an issuer of the primary card for issuing the virtual supplementary card in real time. The issuer validates the details of the beneficiary included in the first request and generates, in real time, an active virtual supplementary card that is linked to the primary card. The issuer further encrypts the virtual supplementary card and provides the encrypted virtual supplementary card to the beneficiary based on the identifier of the second digital account. The encrypted virtual supplementary card is then added to the second digital account of the beneficiary. The second digital account is created by the beneficiary by accessing one of the first application or a second application that is different from the first application. One of the first application or the second application that is associated with the second digital account then initiates a tokenization request for tokenizing the virtual supplementary card and communicates it to a tokenization platform. The tokenization platform tokenizes the virtual supplementary card and transmits a token of the virtual supplementary card to the beneficiary. One of the first application or the second application that is associated with the second digital account then adds the token to the second digital account from where the beneficiary can access it for performing transactions.

Thus, the method and system of the present invention offer advantages to both the primary card holder and the beneficiary as the activated virtual supplementary card is issued to the beneficiary instantly after the primary card holder raises the first request.

### Terms Description (In Addition to Plain and Dictionary Meaning)

Primary cards are transaction cards (such as debit cards, credit cards, prepaid cards, gift cards, promotional cards, and contactless cards and/or other payment means) that are issued by an issuer to a primary account holder of a payment account maintained at the issuer. A primary card can be used to perform electronic transactions (such as deposits, withdrawals, credit transfers, purchase payments, and/or the like) from a payment account to which it is linked. The primary cards may be radio frequency identification (RFID) or NFC enabled for performing contactless payments.

A supplementary card is an add-on card that is provided by an issuer to a beneficiary on a request of a primary card holder of a primary card. The beneficiary is enabled to perform transactions from a payment account linked to the primary card by using the supplementary card. In one embodiment, the supplementary card is a virtual card that is stored in a memory of a device possessed by the beneficiary.

An application is a software program or an application programming interface (API) that is accessed by a user on a device to avail transaction related services. In one embodiment, the application is a digital wallet application hosted by an application server. A user accesses the application and creates a digital account, such as a digital wallet, on the application to perform one or more transactions. Examples of the application include Masterpass®, Google Pay®, Samsung Pay®, Apple Pay®, or the like.

A payment network is a transaction card association that acts as an intermediate entity between acquirers and issuers for processing transactions. Examples of payment networks include Mastercard®, RuPay®, Discover®, Diners Club®, or the like.

User interface (UI) is a graphical interface that includes windows, icons, text boxes, and/or other interactive features to receive inputs from users, provide information, or display output to users. The UI rendered by an application for presenting a digital account to a user includes various options that are selectable by the user. One such option enables the user to procure a virtual supplementary card that is linked to her primary card for a beneficiary.

Issuer is a financial institution, where payment accounts of several users are established and maintained. The issuer ensures payment for authorized transactions in accordance with various payment network regulations and local legislation.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of an application server, a payment network server, or an issuer server.

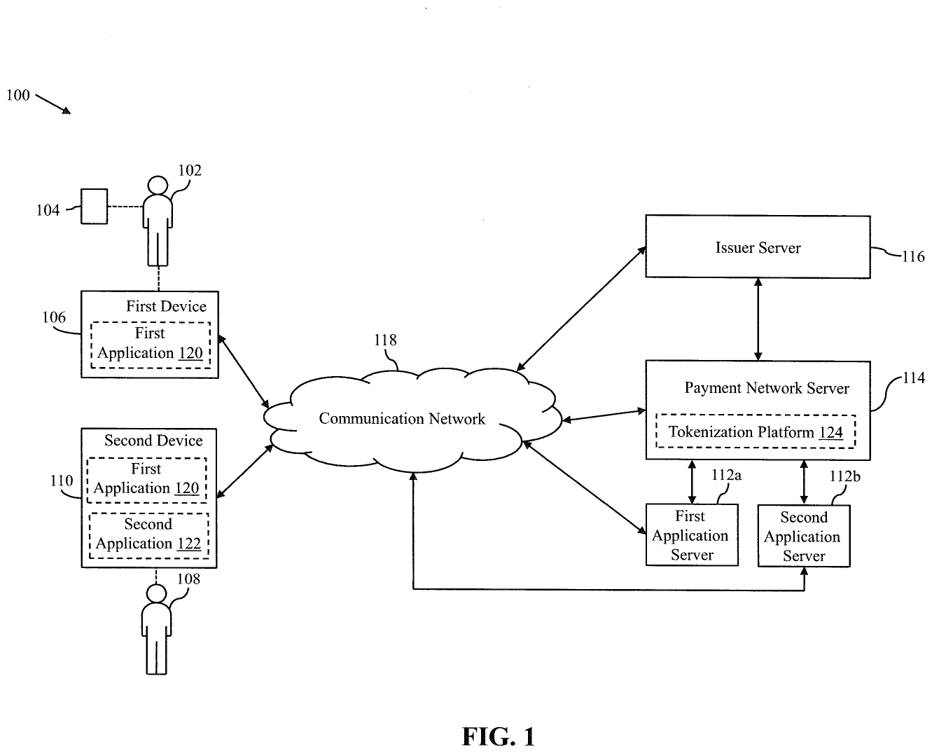

FIG. 1 is a block diagram that illustrates an exemplary environment 100 in which various embodiments of the present invention are practiced. The environment 100 includes a first user 102 in possession of a primary card 104 and a first device 106. Hereinafter, the first user 102 is referred to as “primary card holder 102”. The environment 100 further includes a second user 108 in possession of a second device 110, a first application server 112a, a second application server 112b, a payment network server 114, and an issuer server 116. The first and second devices 106 and 110, the first application server 112a, the second application server 112b, the payment network server 114, and the issuer server 116 communicate with each other by way of a communication network 118 or through separate communication networks established therebetween.

The primary card holder 102 is an individual, who is an account holder of a payment account maintained at a financial institution, such as an issuer. The payment account is linked to a contact number, an electronic mail (e-mail) ID, and verification information, such as permanent address, of the primary card holder 102, as a part of a customer registration procedure performed by the issuer. The primary card holder 102 is entitled to perform electronic transactions (hereinafter referred to as “transactions”) from the payment account by using the primary card 104 issued by the issuer.

The primary card 104 is a payment means linked to the payment account and stores information (hereinafter referred to as “account information”) of the payment account. The account information may be stored in an electronic chip or a machine-readable magnetic strip embedded in the primary card 104. The account information may include an account number, name of the primary card holder 102, and the like. The primary card 104 has a unique card number, an expiry date, a card security code, a card type, and a card brand associated to it. The card number, the expiry date, the card security code, the card type, and the card brand, collectively, correspond to card details of the primary card 104. In one embodiment, the primary card 104 is a physical card. In another embodiment, the primary card 104 is a virtual card that is stored in an encrypted format in a memory (not shown) of the first device 106. Examples of the primary card 104 include a credit card, a debit card, a charge card, a prepaid card, a gift card, an electronic cash card, or the like.

The first device 106 is a communication device of the primary card holder 102. The primary card holder 102 uses the first device 106 for accessing a first application 120. The first application 120 may be a mobile application or a web application. In a scenario where the first application 120 is a mobile application, the primary card holder 102 installs the first application 120 on the first device 106 for accessing it. In another scenario where the first application 120 is a web application, the primary card holder 102 accesses the first application 120 by way of a web-browser installed on the first device 106. Examples of the first device 106 include, but are not limited to, a mobile phone, a smartphone, a laptop, a tablet, a phablet, or any other communication device.

The first application 120 is a wallet application that offers various transaction related services to the primary card holder 102. The first application 120 may be hosted by one of the payment network server 114, the issuer server 116, or a third-party server (e.g., the first application server 112a that aggregates various payment networks, issuers, acquirers, and/or merchants), such that the first application 120 serves as a gateway to the hosting entity. In a non-limiting example, it is assumed that the first application server 112a hosts the first application 120. When the primary card holder 102 accesses the first application 120 on the first device 106, the first application 120 renders a user interface (UI). The UI presents a first option (e.g. a sign-up option) to the primary card holder 102 for creating a first digital account (for example, a first wallet account) on the first application 120. When the primary card holder 102 selects the first option, the UI prompts the primary card holder 102 to enter her registration details (for example, a login ID and a login password, her name, mobile number, email ID, or the like) through the UI. The first application 120 then creates the first digital account and stores it in a memory of the first application server 112a hosting the first application 120. The first digital account is linked to a first account identifier (for example, a first wallet identifier) that uniquely identifies the first digital account.

After the first digital account is created, the UI displays a second option (e.g. ‘add card’) to the primary card holder 102 for adding the primary card 104 to the first digital account. When the primary card holder 102 selects the second option, the UI prompts the primary card holder 102 to provide the card details of the primary card 104. The primary card holder 102 provides the card details through the UI. The first application 120 then creates a virtual copy of the primary card 104 and adds it to the first digital account. The virtual copy of the primary card 104 is stored in an encrypted format in the memory of the first application server 112a. After the primary card 104 is added to the first digital account, the primary card holder 102 can perform transactions by using the virtual copy of the primary card 104 through the first digital account. In one embodiment, the first application 120 may initiate tokenization of the primary card 104 and store a token of the primary card 104 in the first digital account using which the primary card holder 102 performs the transactions.

The UI further displays a third option to the primary card holder 102. The third option, when selected, allows the primary card holder 102 to procure a virtual supplementary card that is linked to the primary card 104 or any other transaction card of the primary card holder 102 that is not added to the first digital account, for a beneficiary in real time. When the primary card holder 102 selects the third option, the UI prompts the primary card holder 102 to enter the information of the beneficiary for whom the virtual supplementary card is to be procured. In one embodiment, the beneficiary may be the second user 108. In another embodiment, the beneficiary may be the primary card holder 102 herself. Based on the information of the beneficiary provided by the primary card holder 102, the first application 120 initiates a first request for issuing the virtual supplementary card to the beneficiary. Based on the first request, the beneficiary instantly receives an active virtual supplementary card and is entitled to perform transactions by using the active virtual supplementary card. In one embodiment, when the primary card holder 102 requests to issue the virtual supplementary card for another transaction card that is not added to the first digital account, the UI prompts the primary card holder 102 to enter the card details of the other transaction card along with the information of the beneficiary.

The second user 108 is an individual, who has created a second digital account (for example, a second wallet account) on a second application 122 accessed on the second device 110 and a third digital account (for example, a third wallet account) on the first application 120 accessed on the second device 110. The second application 122 is functionally similar to the first application 120 and offers various transaction related services to the second user 108. The second and third digital accounts are created in a similar manner as the first digital account and have transaction cards of the second user 108 added to them. The second and third digital accounts are linked to second and third account identifiers (for example, second and third wallet identifiers) that uniquely identify the second and third digital accounts, respectively. In one embodiment, when the second user 108 is the beneficiary of the virtual supplementary card requested by the primary card holder 102, the second application 122 or the first application 120 may receive the virtual supplementary card in an encrypted format based on the account identifier provided by the primary card holder 102. For example, when the primary card holder 102 provides the second account identifier as the information of the beneficiary, the second application 122 receives the virtual supplementary card and adds it to the second digital account. In another example, when the primary card holder 102 provides the third account identifier as the information of the beneficiary, the first application 120 on the second device 110 receives the virtual supplementary card and adds it to the third digital account. The second user 108 can access the virtual supplementary card added to one of the second or third digital account for performing transactions from the payment account of the primary card holder 102. Examples of the second device 110 include, but are not limited to, a mobile phone, a smartphone, a laptop, a tablet, a phablet, or any other communication device.

In one embodiment, the second application 122 or the first application 120 communicates a tokenization request to a tokenization platform 124 for tokenizing the virtual supplementary card that is added to the second or third digital account, respectively. A token for the virtual supplementary card received from the tokenization platform 124 is then added to the second or third digital account by the second application 122 or the first application 120, respectively. The second user 108 then uses the added token to perform the transactions from the payment account of the primary card holder 102.

The first application server 112a is a computing server that is operated by a first wallet service provider. The first application server 112a hosts the first application 120 that is executable on various devices (such as the first device 106 and the second device 110) for providing transaction related services to the users (such as the primary card holder 102 and the second user 108). The first application server 112a maintains digital accounts (for example, the first and third digital accounts) of various users (for example, the first and second users 102 and 108) created through one or more instances of the first application 120. The first application server 112a further stores user profiles corresponding to the digital accounts of the users. A user profile linked to a digital account stores login ID and login password of the corresponding digital account, details of various transaction cards added to the digital account, and purchase history linked to the digital account. Such information is stored in an encrypted format in the memory of the first application server 112a or on a cloud server associated with the first application server 112a, for ensuring data security.

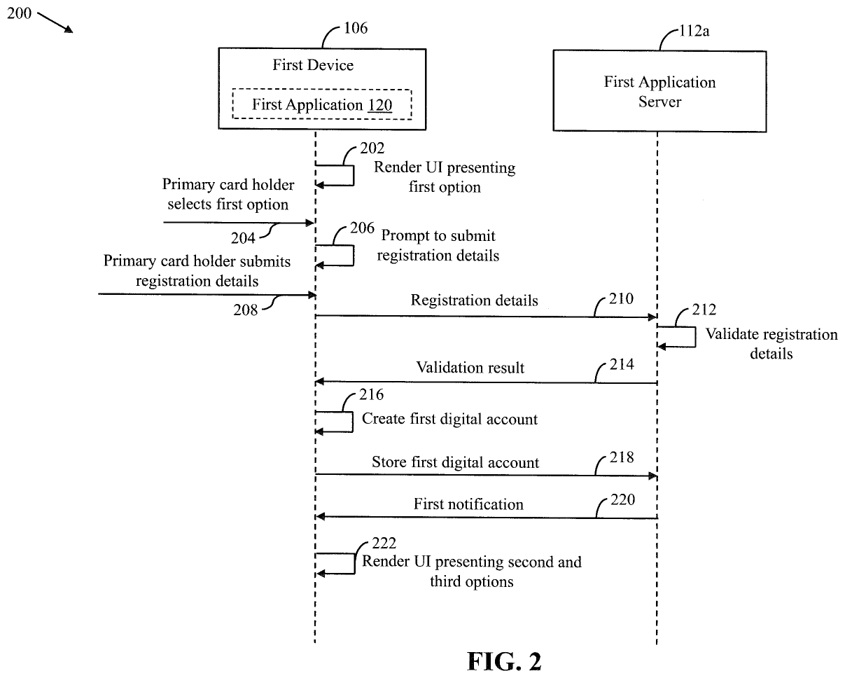

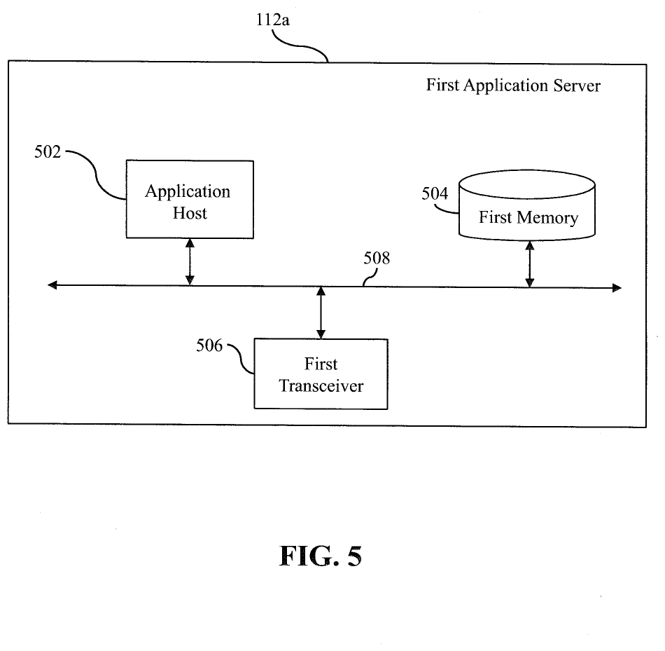

When the primary card holder 102 selects the third option presented on the UI, the first application server 112a communicates the first request, initiated by the first application 120, to a payment network associated with the primary card 104. In one embodiment, when the digital account of the beneficiary of the virtual supplementary card is maintained at the first application server 112a, the first application server 112a receives the virtual supplementary card from the issuer of the primary card 104. The first application server 112a then instructs the first application 120 to add the virtual supplementary card to the digital account of the beneficiary. The first application server 112a further facilitates the tokenization of the virtual supplementary card initiated by the first application 120. Functionality of the first application server 112a is explained in detail in conjunction with FIGS. 2, 3, and 4A-4C. Various functional components of the first application server 112a are explained in detail in conjunction with FIG. 5.

Likewise, the second application server 112b is a computing server that is operated by a second wallet service provider. The second application server 112b hosts the second application 122 that is executable on various devices (such as the second device 110) for providing transaction related services to the users. It will be understood by those of ordinary skill in the art that the second application server 112b is structurally and functionally similar to the first application server 112a.

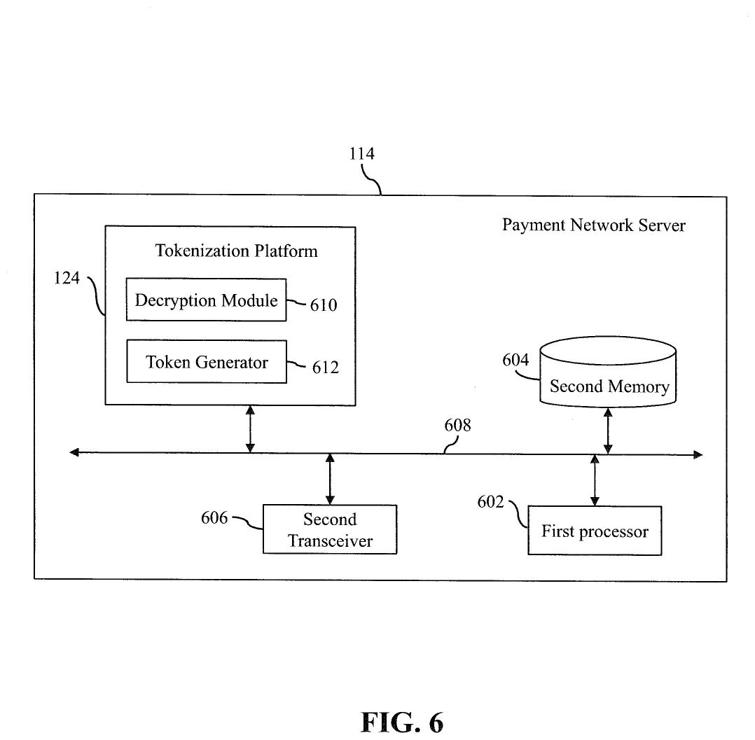

The payment network server 114 is a computing server operated by the payment network. The payment network server 114 serves as an intermediate entity between various wallet providers (such as the first and second application servers 112a and 112b) and issuers (such as the issuer server 116). In a non-limiting example, the payment network server 114 is shown to host the tokenization platform 124. The tokenization platform 124 receives tokenization requests from various application servers, such as the first and second application servers 112a and 112b. A tokenization request includes card details of a transaction card and an account identifier of a digital account in which a token for the transaction card is to be added. The tokenization platform 124 generates the token and transmits the token to the corresponding application server for adding it to the corresponding digital account. Various functional components of the payment network server 114 are explained in detail in conjunction with FIG. 6.

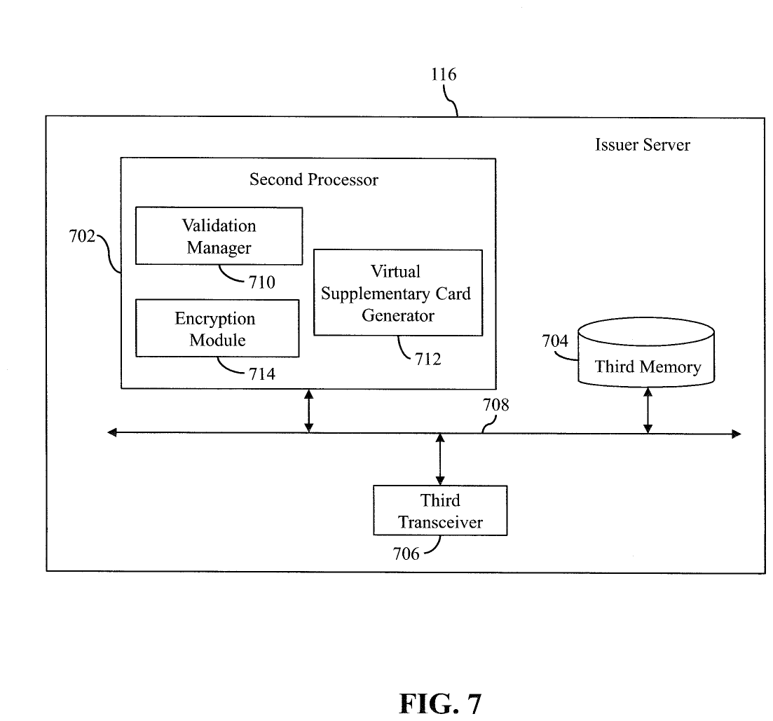

The issuer server 116 is a computing server that is operated by the issuer. The issuer is a financial institution that manages payment accounts of multiple users, such as the primary card holder 102. The account information of the payment accounts maintained at the issuer is stored in a memory of the issuer server 116 or on a cloud server associated with the issuer server 116. The issuer server 116 receives various requests for issuing virtual supplementary cards. The issuer server 116 validates the information included in each request and authorizes the corresponding beneficiaries. When the information is valid and the beneficiaries are authorized, the issuer server 116 generates the virtual supplementary cards and provides them to the corresponding beneficiaries. The issuer server 116 activates and encrypts the virtual supplementary cards prior to providing them to the corresponding beneficiaries. Various functional components of the issuer server 116 are explained in detail in conjunction with FIG. 7.

Though the first application server 112a is depicted as a separate entity, a person skilled in the art will appreciate that in other embodiments the functionality of the first application server 112a may be implemented within the payment network server 114 or the issuer server 116. In another embodiment, the tokenization platform 124 may be hosted by one of the issuer server 116 or a third-party tokenization server without deviating from the scope of the invention. Examples of the first application server 112a, the second application server 112b, the payment network server 114, and the issuer server 116 include, but are not limited to, computers, laptops, mini-computers, mainframe computers, any non-transient and tangible machines that can execute a machine-readable code, cloud-based servers, distributed server networks, a network of computer systems, or a combination thereof.

The communication network 118 is a medium through which content and messages are transmitted between the first and second devices 106 and 110, the first application server 112a, the second application server 112b, the payment network server 114, and the issuer server 116, and/or other entities that are pursuant to one or more standards for the interchange of transaction messages, such as the ISO8583 standard. Examples of the communication network 118 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 118 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

FIG. 2 is a process flow diagram 200 that illustrates creation of a digital account of a user, in accordance with an embodiment of the present invention. For the sake of simplicity, the creation of the digital account is described with respect to the first digital account of the primary card holder 102. The process flow diagram 200 involves the first device 106, the first application server 112a, and the first application 120.

The primary card holder 102 accesses the first application 120 on the first device 106. In one embodiment, the primary card holder 102 may download the first application 120 from an application store hosted by the first application server 112a and install it on the memory of the first device 106. In another embodiment, the primary card holder 102 may access the first application 120 through the web-browser installed on the first device 106. The first application 120 renders the UI on a display of the first device 106 and the UI presents the first option (e.g., a sign-up option) to the primary card holder 102 (as shown by arrow 202). The first option is selectable by the primary card holder 102 for creating the first digital account on the first application 120. The primary card holder 102 selects the first option (as shown by arrow 204).

Based on the selection of the first option, the UI prompts the primary card holder 102 to submit her details for registration, such as a login ID, a login password, a contact number, an e-mail ID, name, age, or the like (as shown by arrow 206). The primary card holder 102 submits the registration details through the UI (as shown by arrow 208). Since the first application 120 is a gateway to the first application server 112a, it communicates the registration details to the first application server 112a (as shown by arrow 210). The first application server 112a validates the registration details (as shown by arrow 212). For example, the first application server 112a performs e-mail ID and contact number verification to validate the e-mail ID and the contact number provided by the primary card holder 102 as part of the registration details. The first application server 112a communicates a result of the validation to the first application 120 (as shown by arrow 214). In one embodiment, the result of validation may indicate that the registration details are valid. In another embodiment, the result of validation may indicate that the registration details are invalid.

In response to successful validation of the registration details, the first application 120 initiates the creation of the first digital account (as shown by arrow 216). The first application 120 then stores the first digital account in the memory of the first application server 112a (as shown by arrow 218). When the first digital account is successfully stored, a user profile of the primary card holder 102 is created in the memory of the first application server 112a. The first application server 112a communicates a first notification to the first application 120 for indicating that the first digital account is created successfully (as shown by arrow 220). After the first notification is received, the first application 120 presents the second and third options to the primary card holder 102 through the UI (as shown by arrow 222). The second and third options are selectable by the primary card holder 102. The second option enables the primary card holder 102 to add her transaction card (such as the primary card 104) to the first digital account. The third option enables the primary card holder 102 to request for a virtual supplementary card for any transaction card that is already added to the first digital account or other transaction cards that are not added to the first digital account.

It will be understood by those of ordinary skill in the art that the second and third digital accounts of the second user 108 are created in a similar manner as described in the process flow diagram 200. For example, the creation of the second digital account involves the second device 110, the second application server 112b, and the second application 122. Likewise, the creation of the third digital account involves the second device 110, the first application server 112a, and the first application 120.

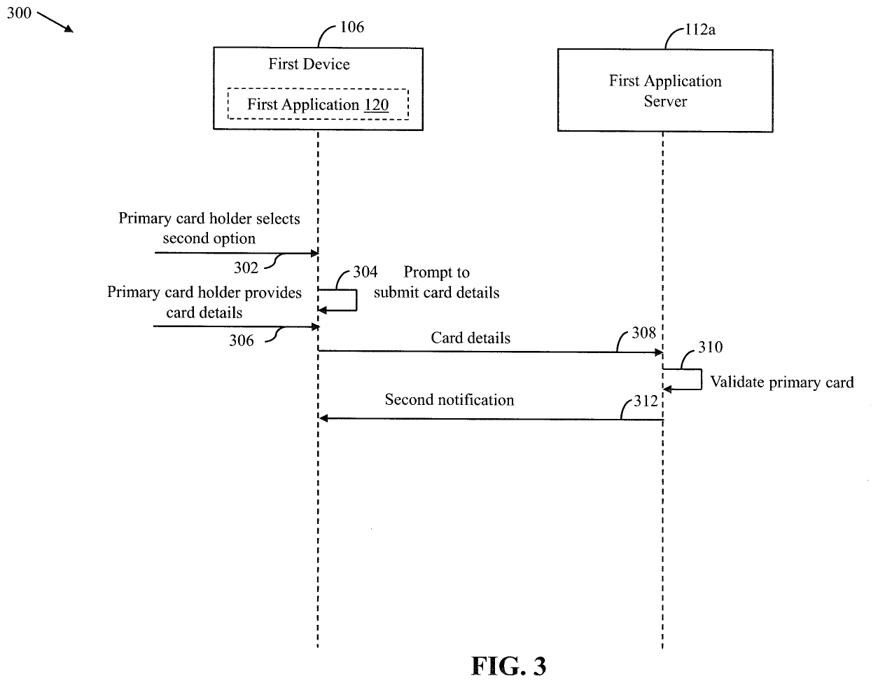

FIG. 3 is a process flow diagram 300 that illustrates addition of a transaction card to a digital account of a user, in accordance with an embodiment of the present invention. For the sake of simplicity, the addition of the transaction card is described with respect to the addition of the primary card 104 to the first digital account. The process flow diagram 300 involves the first device 106, the first application 120, and the first application server 112a.

For adding the primary card 104 to the first digital account, the primary card holder 102 selects the second option (as described in FIG. 2) presented on the UI (as shown by arrow 302). Based on the selection of the second option, the UI prompts the primary card holder 102 to submit the card details (such as the card number, the expiry date, or the like) of the primary card 104 that she wants to add to the first digital account (as shown by arrow 304). The primary card holder 102 provides the card details of the primary card 104 (as shown by arrow 306). The first application 120 communicates the card details to the first application server 112a (as shown by arrow 308). The first application server 112a validates the primary card 104 based on the card details (as shown by arrow 310) and communicates a second notification to the first application 120 (as shown by arrow 312). The second notification indicates the result of validation of the primary card 104. When the second notification indicates that the primary card 104 is valid, the first application 120 adds the primary card 104 to a list of transaction cards added to the first digital account. When the primary card 104 is added to the first digital account, a virtual copy of the primary card 104 is stored in the user profile linked to the first digital account. Once the primary card 104 is added to the first digital account, the primary card holder 102 can use the added primary card 104 for performing transactions through the first digital account.

It will be apparent to a person having ordinary skill in the art that the second user 108 adds her transaction cards to the second and third digital accounts in a similar manner as described in the process flow diagram 300.

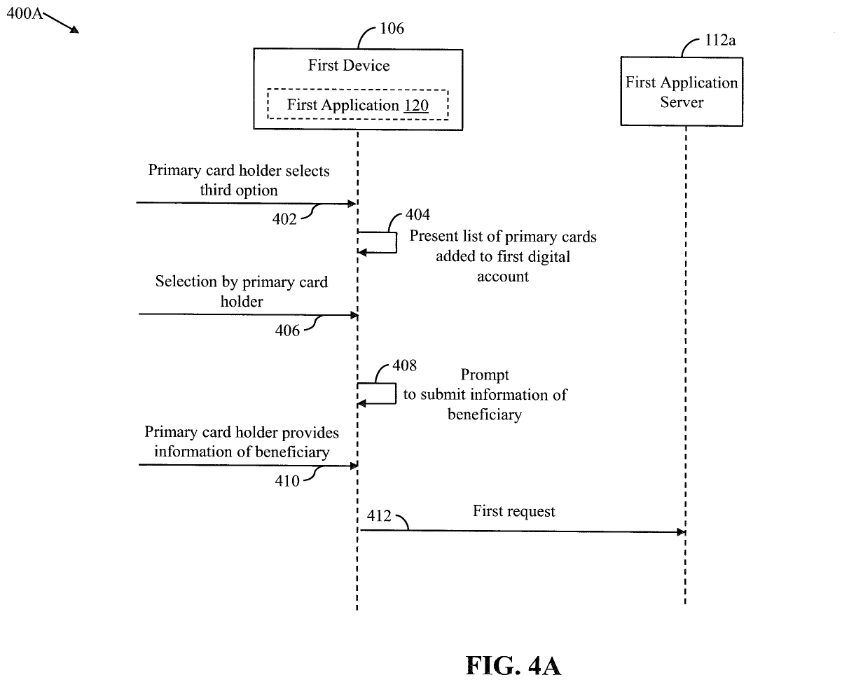

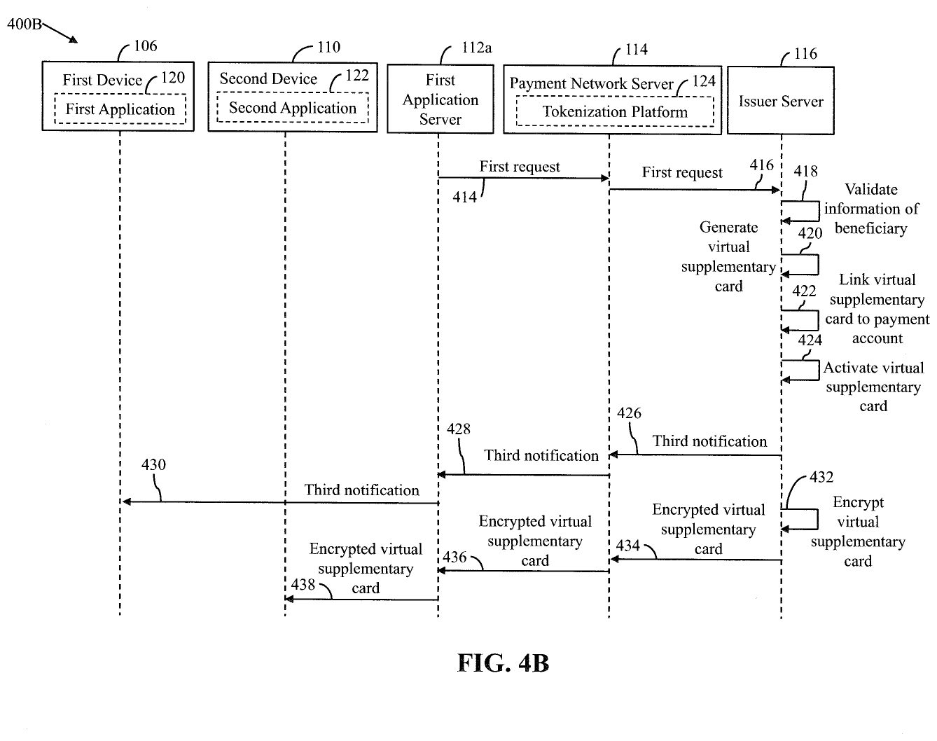

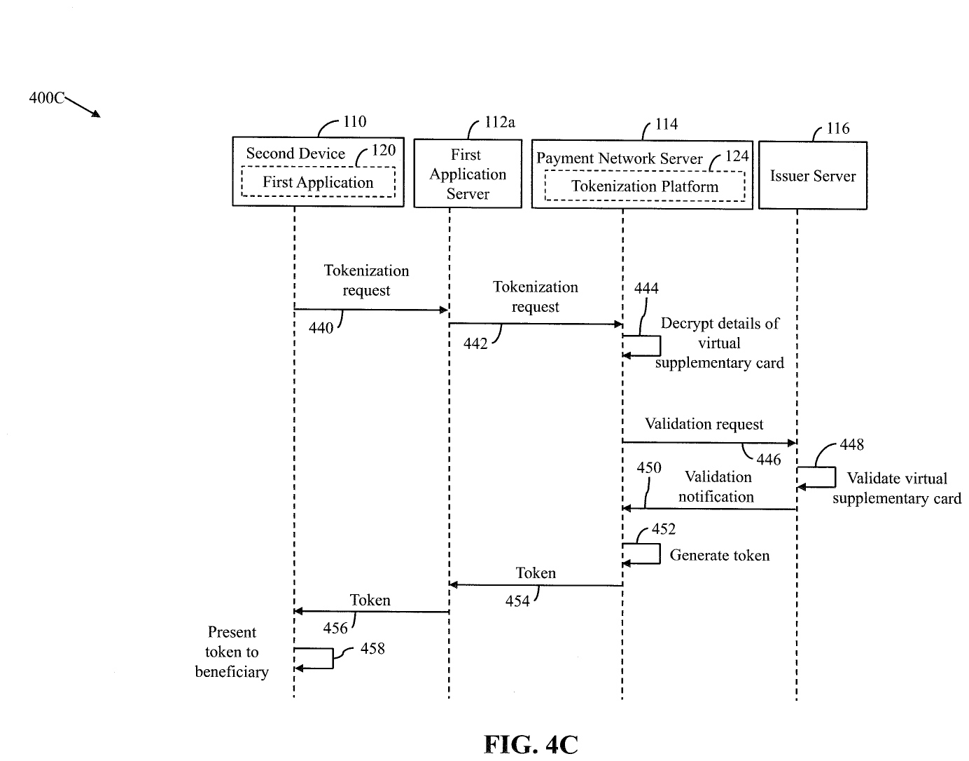

FIGS. 4A-4C represent process flow diagrams 400A-400C that illustrate an exemplary scenario where a virtual supplementary card is issued to a beneficiary in real time based on a request of the primary card holder 102, in accordance with an embodiment of the present invention.

With reference to FIG. 4A, the process flow diagram 400A illustrates a scenario where the primary card holder 102 initiates a request to procure a virtual supplementary card for a beneficiary of her choice. The primary card holder 102 selects the third option presented on the UI (as described in FIG. 2) to procure a virtual supplementary card for a beneficiary (as shown by arrow 402). Based on the selection of the third option, the UI presents a list of transaction cards, such as the primary card 104, added to the first digital account (as shown by arrow 404). The primary card holder 102 may select a primary card from the list of added transaction cards to procure the virtual supplementary card. The UI further presents an alternate option to the primary card holder 102 that allows the primary card holder 102 to procure the virtual supplementary card for a primary card that is not added to the first digital account. For the sake of ongoing description, it is assumed that the primary card holder 102 selects the primary card 104 from the list of added transaction cards (as shown by arrow 406).

In response to the selection of the primary card 104, the UI prompts the primary card holder 102 to submit the information of the beneficiary (as shown by arrow 408). The information of the beneficiary includes a name of the beneficiary, an account identifier of a digital account of the beneficiary, a contact number, an e-mail ID, or the like of the beneficiary. In a non-limiting example, it is assumed that the primary card holder 102 provides the information of the second user 108, who is the beneficiary (as shown by arrow 410). For the sake of ongoing description, it is assumed that the primary card holder 102 provides the third account identifier that is linked to the third digital account of the second user 108. Based on the information provided by the primary card holder 102, the first application 120 initiates the first request and communicates it to the first application server 112a (as shown by arrow 412). The first request is for issuing the virtual supplementary card linked to the primary card 104 to the second user 108 in real time. The first request includes the information of the second user 108 (i.e., the beneficiary) provided by the primary card holder 102.

In another embodiment, when the primary card holder 102 does not select any primary card from the list of added transaction cards and wants to procure the virtual supplementary card for another primary card that is not added to the first digital account, the UI prompts the primary card holder 102 to submit the primary card details of the other primary card along with the information of the beneficiary.

With reference to FIG. 4B, the process flow diagram 400B illustrates a scenario where the second user 108 (i.e., the beneficiary) receives the virtual supplementary card based on the first request. The process flow diagram 400B involves the first device 106, the second device 110, the first application server 112a, the payment network server 114, the issuer server 116, the first application 120, and the second application 122.

The first application server 112a identifies the payment network server 114 associated with the primary card 104 and communicates the first request to the payment network server 114 (as shown by arrow 414). The payment network server 114 identifies the issuer associated with the primary card 104 based on the first request, and communicates the first request to the issuer server 116 of the identified issuer (as shown by arrow 416). The issuer server 116 receives the first request and validates the information of the second user 108 (i.e., the beneficiary) included in the first request (as shown by arrow 418). For example, the issuer server 116 may communicate with the first application server 112a by way of the payment network server 114 to check whether the third account identifier corresponds to an active digital account of the beneficiary mentioned in the first request. When the information of the second user 108 (i.e., the beneficiary) is determined to be valid, the issuer server 116 generates the virtual supplementary card for issuing to the second user 108 (as shown by arrow 420). The issuer server 116 links the virtual supplementary card to the payment account of the primary card holder 102 (as shown by arrow 422) and, then, activates the virtual supplementary card (as shown by arrow 424). The activation of the virtual supplementary card ensures that the second user 108 is able to perform transactions instantly on the reception of the virtual supplementary card. The issuer server 116 further generates a third notification for indicating a successful generation of the virtual supplementary card. The issuer server 116 communicates the third notification to the first application server 112a by way of the payment network server 114 (as shown by arrows 426 and 428). The first application server 112a identifies the source of the first request, which is the first digital account of the primary card holder 102, and instructs the first application 120 to present the third notification to the primary card holder 102 by way of the first digital account (as shown by arrows 430).

The issuer server 116 then encrypts the virtual supplementary card using an encryption key (as shown by arrow 432). The encryption key used by the issuer server 116 is uniquely associated with the third account identifier of the third digital account. In one embodiment, the issuer server 116 transmits the encrypted virtual supplementary card along with the third account identifier to the payment network server 114 (as shown by arrow 434), which further transmits the encrypted virtual supplementary card and the third account identifier to the first application server 112a (as shown by arrow 436). The first application server 112a identifies that the virtual supplementary card is to be added to the third digital account. Thus, the first application server 112a provides the encrypted virtual supplementary card to the first application 120 installed or accessed on the second device 110 (as shown by arrow 438). The first application 120 then adds the virtual supplementary card to the third digital account of the second user 108.

In another embodiment, the issuer server 116 may communicate the virtual supplementary card to the primary card holder 102, such that the first application 120 installed on the first device 106 communicates the virtual supplementary card to the second user 108 (i.e., the beneficiary). In another embodiment, the primary card holder 102 may specify the second account identifier of the second digital account instead of the third digital account identifier, while initiating the first request. In such a scenario, the second application server 112b receives the virtual supplementary card from the payment network server 114 and the second application 122 adds the virtual supplementary card to the second digital account of the second user 108. In yet another embodiment, the primary card holder 102 may specify the first account identifier of her digital account while initiating the first request. In such a scenario, the first application server 112a receives the virtual supplementary card from the payment network server 114 and the first application 120 adds the virtual supplementary card to the first digital account of the primary card holder 102.

With reference to FIG. 4C, the process flow diagram 400C illustrates a scenario where the first application 120, accessed on the second device 110, facilitates tokenization of the received virtual supplementary card. The process flow diagram 400C involves the second device 110, the first application server 112a, the payment network server 114, the issuer server 116, and the first application 120.

When the first application 120 accessed on the second device 110 determines that the virtual supplementary card is received and added to the third digital account, the first application 120 initiates a tokenization request and communicates it to the first application server 112a (as shown by arrow 440). The tokenization request is a request for tokenizing the virtual supplementary card for enabling the second user 108 (i.e., the beneficiary) to perform secure transactions using the virtual supplementary card. The tokenization request includes the details of the virtual supplementary card in an encrypted format and the third digital account identifier of the third digital account. The first application server 112a then communicates the tokenization request to the tokenization platform 124 (as shown by arrow 442). In this scenario, the tokenization platform 124 is hosted by the payment network server 114, thus the payment network server 114 receives the tokenization request from the first application server 112a. However, if the tokenization platform 124 is hosted by any entity other than the payment network server 114, the entity hosting the tokenization platform 124 receives the tokenization request, without deviating from the scope of the invention.

Based on the tokenization request, the tokenization platform 124 decrypts the details of the virtual supplementary card (as shown by arrow 444). The tokenization platform 124 identifies the issuer server 116 associated with the virtual supplementary card and communicates a validation request to the issuer server 116 for validating (i.e., performing a card eligibility check) the virtual supplementary card (as shown by arrow 446). The validation request includes the details of the virtual supplementary card, such as a virtual supplementary card number. In response to the validation request, the issuer server 116 validates the virtual supplementary card and approves the tokenization of the virtual supplementary card (as shown by arrow 448). The issuer server 116 communicates a validation notification to the tokenization platform 124 to indicate a result of validation of the virtual supplementary card (as shown by arrow 450). In one embodiment, the validation notification may indicate that the virtual supplementary card is valid and allowed to be tokenized. In another embodiment, the validation notification may indicate that the virtual supplementary card is invalid.

Based on the successful validation of the virtual supplementary card, the tokenization platform 124 generates a token for the virtual supplementary card (as shown by arrow 452). The token includes a token number linked to the virtual supplementary card number of the beneficiary. The token number is a randomly generated alphanumeric code that is only accessible through the third digital account. The tokenization platform 124 communicates the token along with the third digital account identifier to the first application server 112a (as shown by arrow 454). Based on the third digital account identifier received with the token, the first application server 112a communicates the token to the first application 120 accessed on the second device 110 of the second user 108 (as shown by arrow 456). The first application 120 accessed on the second device 110 then adds the token as an available payment option in the third digital account and presents the token to the second user 108 (as shown by arrow 458). The second user 108 (i.e., the beneficiary) may use the token saved in the third digital account to perform various transactions.

In another embodiment, when the virtual supplementary card is added to the second digital account of the second user 108, the process flow diagram 400C is implemented by the second application 122 in conjunction with the second application server 112b for facilitating the tokenization of the received virtual supplementary card. In one embodiment, the first application 120 installed on the first device 106 facilitates the tokenization of the primary card 104 added to the first digital account by implementing the process flow diagram 400C.

FIG. 5 is a block diagram that illustrates the first application server 112a, in accordance with an embodiment of the present invention. The first application server 112a includes an application host 502, a first memory 504, and a first transceiver 506 that communicate with each other via a first bus 508. It will be understood by those of ordinary skill in the art that the second application server 112b is functionally similar to the first application server 112a and may be implemented by the block diagram of FIG. 5.

The application host 502 includes suitable logic, circuitry, and/or interfaces to execute operations for hosting the first application 120 that is executable on various devices, such as the first and second devices 106 and 110. The application host 502 controls the first application 120 and causes it to perform various operations (such as rendering of the UI) as described in FIGS. 2, 3, and 4A-4C. The application host 502 receives the data and information (such as the registration details, the card details, the beneficiary details, or the like) that the users (such as the primary card holder 102 and the second user 108) enter through the UI rendered by the first application 120 and stores it in the first memory 504. Examples of the application host 502 include, but are not limited to, an application-specific integrated circuit (ASIC) processor, a reduced instruction set computing (RISC) processor, a complex instruction set computing (CISC) processor, a field-programmable gate array (FPGA), or the like.

The first memory 504 includes suitable logic, circuitry, and/or interfaces to store the user profiles of various users (such as the primary card holder 102 and the second user 108) who have created digital accounts by accessing the first application 120. The information (such as login ID and password, details of various transaction cards, and purchase history) included in each user profile is stored in an encrypted format to ensure data security to the users. The first memory 504 further stores a set of codes, instructions, programs, or the like, which enables the application host 502 to host the first application 120. Examples of the first memory 504 include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the first memory 504 in the first application server 112a, as described herein. In another embodiment, the first memory 504 may be realized in form of a database server or a cloud storage working in conjunction with the first application server 112a, without departing from the scope of the invention.

The first transceiver 506 includes suitable logic, circuitry, and/or interfaces that transmits and receives data over the communication network 118 using one or more communication network protocols. The first transceiver 506, in conjunction with the application host 502, transmits/receives various requests and messages to/from the payment network server 114 and the issuer server 116, or other entities that are pursuant to one or more standards for the interchange of transaction messages (such as the ISO8583 standard). For example, the first transceiver 506 communicates the first request for issuing the virtual supplementary card to the payment network server 114 and receives the encrypted virtual supplementary card from the issuer server 116. The first transceiver 506 further communicates the tokenization request to the tokenization platform 124 for facilitating the tokenization of transaction cards added to the digital accounts of the users as explained in FIGS. 2, 3, and 4A-4C. Examples of the first transceiver 506 include, but are not limited to, an antenna, a radio frequency transceiver, a wireless transceiver, a Bluetooth transceiver, an ethernet port, a universal serial bus (USB) port, or any other device configured to transmit and receive data.

FIG. 6 is a block diagram that illustrates the payment network server 114, in accordance with an embodiment of the present invention. The payment network server 114 includes a first processor 602, the tokenization platform 124, a second memory 604, and a second transceiver 606 that communicate with each other via a second bus 608.

The first processor 602 includes suitable logic, circuitry, and/or interfaces to execute operations such as identification of issuers when requests for issuing virtual supplementary cards are received. For example, the first processor 602 identifies an issuer who has issued the primary card 104 to the primary card holder 102, when the primary card holder 102 raises the request for issuing the virtual supplementary card that is linked to the primary card 104. Examples of the first processor 602 include, but are not limited to, an ASIC processor, a RISC processor, a CISC processor, an FPGA, or the like.

The tokenization platform 124 includes suitable logic, circuitry, and/or interfaces to execute operations for tokenizing transaction cards, such as the primary card 104 and the virtual supplementary card, as explained in FIG. 4C. The tokenization platform 124 includes a decryption module 610 and a token generator 612. The decryption module 610 executes operations for decrypting encrypted information of transaction cards for tokenization. The token generator 612 executes operations for generating tokens for the transaction cards, such as the primary card 104 and the virtual supplementary card, as explained in FIG. 4C. For example, the token generator 612 generates a random alphanumeric code (i.e., the token) to represent the information of the transaction card and also stores it in the second memory 604. Examples of the tokenization platform 124 include, but are not limited to, an ASIC processor, a RISC processor, a CISC processor, an FPGA, or the like.

The second memory 604 includes suitable logic, circuitry, and/or interfaces to store information (such as issuer identification numbers) pertaining to associations between transaction cards (such as primary cards and supplementary cards) and issuers. For instance, the second memory 604 stores and maintains a first lookup table that includes the issuer identification number of the issuer that issued the primary card 104 and the virtual supplementary card. The first lookup table is referred by the first processor 602 for identifying the issuer that corresponds to the primary card 104 and/or the virtual supplementary card. The second memory 604 further stores and maintains a second lookup table that includes information pertaining to associations between various tokens and transaction cards. The second lookup table is referred by the first processor 602 for identifying a transaction card that corresponds to a token used for performing a transaction. The second memory 604 further stores a set of codes, instructions, and programs, which enables the tokenization platform 124 to tokenize various transaction cards, such as the primary card 104 and the virtual supplementary card. Examples of the second memory 604 include a RAM, a ROM, a removable storage drive, an HDD, a flash memory, a solid-state memory, or the like. It will be apparent to a person skilled in the art that the scope of the invention is not limited to realizing the second memory 604 in the payment network server 114, as described herein. In another embodiment, the second memory 604 may be realized in form of a database server or a cloud storage working in conjunction with the payment network server 114, without departing from the scope of the invention.

The second transceiver 606 includes suitable logic, circuitry, and/or interfaces that transmits and receives data over the communication network 118 using one or more communication network protocols. The second transceiver 606 transmits/receives various requests and messages to/from the first application server 112a, the second application server 112b, the issuer server 116, or other entities that are pursuant to one or more standards for the interchange of transaction messages (such as the ISO8583 standard). For example, the second transceiver 606 receives various tokenization requests initiated by the first and second applications 120 and 122 and the first request for issuing the virtual supplementary card in real time. Examples of the second transceiver 606 include, but are not limited to, an antenna, a radio frequency transceiver, a wireless transceiver, a Bluetooth transceiver, an ethernet port, a USB port, or any other device configured to transmit and receive data.

FIG. 7 is a block diagram that illustrates the issuer server 116, in accordance with an embodiment of the present invention. The issuer server 116 includes a second processor 702, a third memory 704, and a third transceiver 706 that communicate with each other via a third bus 708.

The second processor 702 includes suitable logic, circuitry, and/or interfaces to execute operations for generation of virtual supplementary cards. The second processor 702 further includes a validation manager 710, a virtual supplementary card generator 712, and an encryption module 714. The validation manager 710 executes operations for performing various validation and authorization operations as described in FIGS. 2, 3, and 4A-4C. For example, the validation manager 710 performs the validation of the primary card 104 and the virtual supplementary card. The virtual supplementary card generator 712 executes various operations pertaining to the generation of the virtual supplementary card as described in FIGS. 2, 3, and 4A-4C. For example, the virtual supplementary card generator 712 generates and activates the virtual supplementary card that is to be issued to the second user 108. The encryption module 714 executes various encryption operations as described in FIGS. 4A-4C. For example, the encryption module 714 generates the encryption key and encrypts the generated virtual supplementary card by using the encryption key before providing it to the beneficiary (i.e., the second user 108). Examples of the second processor 702 include, but are not limited to, an ASIC processor, a RISC processor, a CISC processor, an FPGA, and the like.

The third memory 704 includes suitable logic, circuitry, and/or interfaces to store account profiles of various users (for example, the primary card holder 102) who have their payment accounts maintained at the issuer. An account profile of the primary card holder 102 includes details of her payment account, and details of various primary cards and virtual supplementary cards linked to the payment account. The third memory 704 further stores a list of encryption keys used for encrypting various virtual supplementary cards. The third memory 704 further stores a set of codes, instructions, and programs, which enables the second processor 702 to perform its operations, such as issuing virtual supplementary cards in real time. Examples of the third memory 704 include a RAM, a ROM, a removable storage drive, an HDD, a flash memory, a solid-state memory, and the like. It will be apparent to a person skilled in the art that the scope of the invention is not limited to realizing the third memory 704 in the issuer server 116, as described herein. In another embodiment, the third memory 704 may be realized in form of a database server or a cloud storage working in conjunction with the issuer server 116, without departing from the scope of the invention.

The third transceiver 706 includes suitable logic, circuitry, and/or interfaces that transmits and receives data over the communication network 118 using one or more communication network protocols. The third transceiver 706 transmits/receives various requests and messages to/from the first application server 112a, the payment network server 114, or other entities that are pursuant to one or more standards for the interchange of transaction messages (such as the ISO8783 standard). For example, the third transceiver 706 receives the first request for issuing the virtual supplementary card and the validation request for validating the information of the virtual supplementary card from the payment network server 114. The third transceiver 706 transmits the encrypted virtual supplementary card to the payment network server 114 as described in FIG. 4B. Examples of the third transceiver 706 include, but are not limited to, an antenna, a radio frequency transceiver, a wireless transceiver, a Bluetooth transceiver, an ethernet port, a USB port, or any other device configured to transmit and receive data.

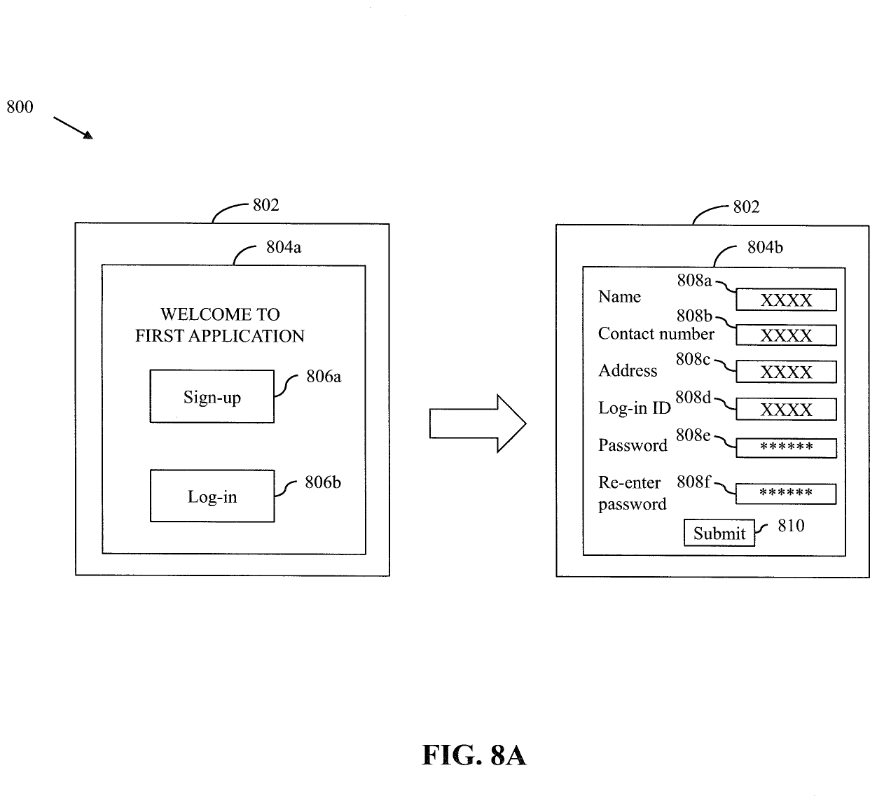

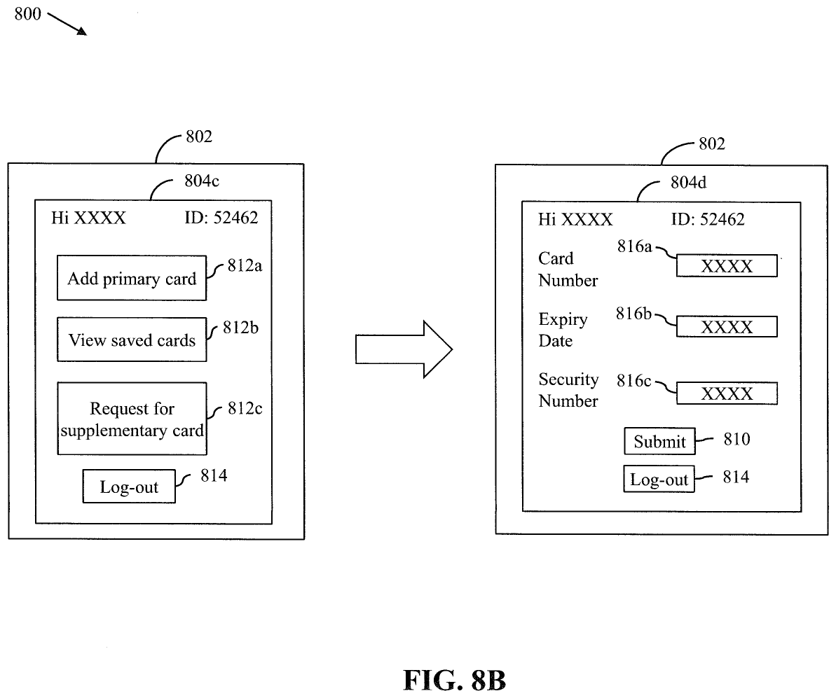

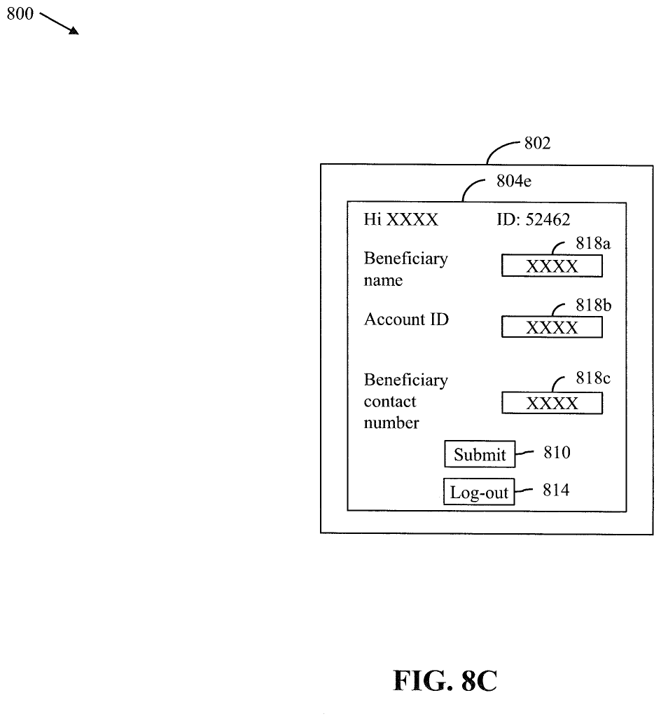

FIGS. 8A-8C represent an exemplary scenario 800 that illustrates a UI 802 of the first application 120, in accordance with an embodiment of the present invention. The UI 802 is rendered on a display (not shown) of a device, when the first application 120 is accessed on the device. For the sake of simplicity, FIGS. 8A-8C are described with reference to the first device 106.

With reference to FIG. 8A, when the primary card holder 102 opens the first application 120 on the first device 106, the UI 802 renders a first UI screen 804a. The first UI screen 804a displays a “sign-up” button 806a and a “log-in” button 806b. The “sign-up” button 806a provides the first option to the primary card holder 102. In other words, the “sign-up” button 806a enables the primary card holder 102 to create the first digital account on the first application 120. The “log-in” button 806b enables the primary card holder 102 to log-in to an already created digital account on the first application 120.

When the primary card holder 102 selects the “sign-up” button 806a, the UI 802 displays a second UI screen 804b which prompts the primary card holder 102 to provide her registration details. The second UI screen 804b includes a first set of text boxes to enable the primary card holder 102 to enter the registration details. The first set of textboxes includes a “name” textbox 808a, a “contact number” textbox 808b, an “address” textbox 808c, a “log-in ID” textbox 808d, a “password” textbox 808e, and a “re-enter password” textbox 808f. The second UI screen 804b further includes a “submit” button 810 that enables the primary card holder 102 to submit the registration details. When the primary card holder 102 selects the “submit” button 810, the first application 120 initiates the creation of the first digital account of the primary card holder 102 as described in FIG. 2.

With reference to FIG. 8B, the UI 802 renders a third UI screen 804c when the first digital account of the primary card holder 102 is successfully created and the primary card holder 102 has logged into the first digital account. The third UI screen 804c displays an “add primary card” button 812a, a “view saved cards” button 812b, and a “request for supplementary card” button 812c. The “add primary card” button 812a provides the second option to the primary card holder 102. In other words, the “add primary card” button 812a enables the primary card holder 102 to add her transaction cards (such as the primary card 104) to the first digital account. The “view saved cards” button 812b enables the primary card holder 102 to view the list of transaction cards which are already added to the first digital account. The “request for supplementary card” button 812c provides the third option to the primary card holder 102. In other words, the “request for supplementary card” button 812c enables the primary card holder 102 to procure a virtual supplementary card for a beneficiary. The third UI screen 804c further displays a “log-out” button 814 which enables the primary card holder 102 to log-out from the first digital account.

When the primary card holder 102 selects the “add primary card” button 812a, the UI 802 displays a fourth UI screen 804d which prompts the primary card holder 102 to enter the card details of a transaction card (such as the primary card 104) that she wishes to add to the first digital account. The fourth UI screen 804d includes a second set of text boxes to enable the primary card holder 102 to enter the card details. The second set of textboxes include a “card number” textbox 816a, an “expiry date” textbox 816b, and a “security number” textbox 816c. The fourth UI screen 804d further includes the “submit” button 810 and the “log-out” button 814.

With reference to FIG. 8C, the UI 802 renders a fifth UI screen 804e on the display of the first device 106. When the primary card holder 102 selects the “request for virtual supplementary card” button 812c of FIG. 8B, the UI 802 presents a list of transaction cards that are added to the first digital account. The primary card holder 102 may select one of the primary cards from the list of added transaction cards for which the virtual supplementary card is to be procured. When the primary card holder 102 selects one of the primary cards from the list of added transaction cards, the UI 802 displays the fifth UI screen 804e to prompt the primary card holder 102 to submit the information of the beneficiary for whom the virtual supplementary card is to be procured. The fifth UI screen 804e includes a third set of text boxes to enable the primary card holder 102 to enter the information of the beneficiary. The third set of textboxes include a “beneficiary name” textbox 818a, an “account ID” textbox 818b, and a “beneficiary contact number” textbox 818c. The fifth UI screen 804e further includes the “submit” button 810 and the “log-out” button 814. In an alternate embodiment, when the primary card holder 102 does not select any primary card from the list of added transaction cards and wants to procure the virtual supplementary card for another primary card that is not added to the first digital account, the fifth UI screen 804e prompts the primary card holder 102 to submit the card details of the other primary card along with the information of the beneficiary. In such a scenario, the fifth UI screen 804e may display the second set of textboxes 816a-816c along with the third set of text boxes 818a-818c, without deviating from the scope of the invention. It will apparent to a person having ordinary skill in the art that the UI 802 is shown for exemplary purposes and should not be construed to limit the scope of the invention.

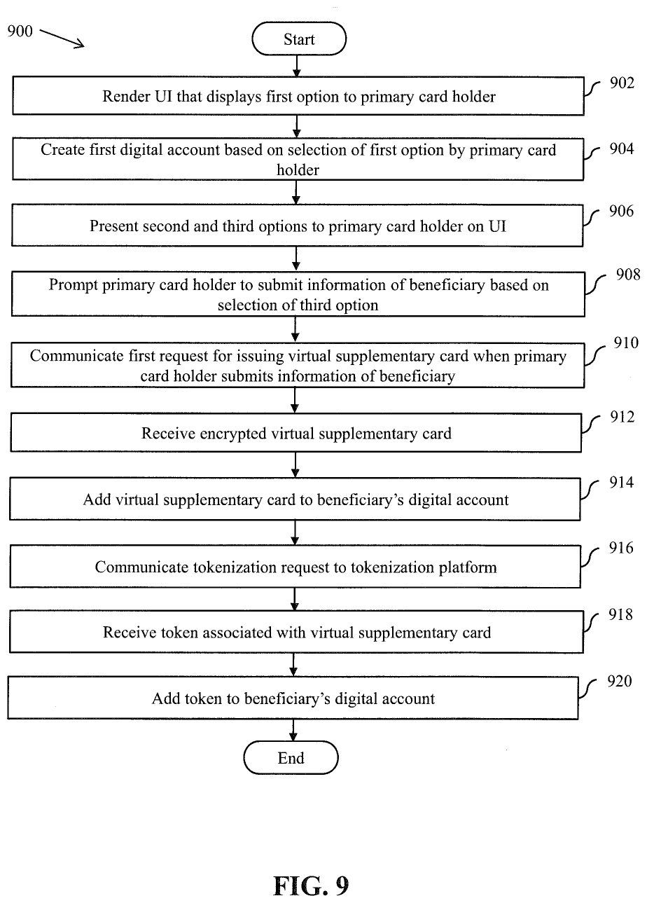

FIG. 9 is a flow chart 900 that illustrates a method for procuring the virtual supplementary card for the beneficiary, in accordance with an embodiment of the present invention. The first application server 112a hosts and maintains the first application 120 that offers transaction related services to various users (such as the primary card holder 102 or the second user 108). The primary card holder 102 accessed the first application 120 on the first device 106.

At step 902, the first application 120 renders the UI 802 on the display of the first device 106 that presents the first option (e.g., the “sign-up” button 806a) to the primary card holder 102. The first option is selectable by the primary card holder 102 for creating the first digital account on the first application server 112a. Based on the selection of the first option, the first application 120 prompts the primary card holder 102 to submit her registration details. At step 904, the first application 120 creates the first digital account based on the selection of the first option by the primary card holder 102 and submission of the registration details. At step 906, the first application 120 presents the second and third options (e.g., the “add primary card” button 812a and the “request for supplementary card” button 812c, respectively) to the primary card holder 102 on the UI 802.

At step 908, the first application 120 prompts the primary card holder 102 to submit the information (such as the third account identifier) of the beneficiary (such as the second user 108) to whom the virtual supplementary card is to be issued. At step 910, the first application 120 communicates the first request for issuing the virtual supplementary card to the issuer server 116 when the primary card holder 102 submits the information of the beneficiary. At step 912, the first application 120 receives the encrypted virtual supplementary card generated by the issuer server 116. The first application 120 presents the third notification to the primary card holder 102 to indicate that the virtual supplementary card is successfully generated. At step 914, the first application 120 adds the virtual supplementary card to the beneficiary's digital account (e.g., the third digital account).

At step 916, the first application 120 communicates the tokenization request to the tokenization platform 124 for tokenizing the encrypted virtual supplementary card, when the virtual supplementary card is added to the beneficiary's digital account (e.g., the third digital account. At step 918, the first application 120 receives the token for the virtual supplementary card from the tokenization platform 124. At step 920, the first application 120 adds the received token to the beneficiary's digital account (e.g., the third digital account). Thus, the beneficiary utilizes the token for performing the transactions through the virtual supplementary card.

In an alternate embodiment, steps 912 to 920 are performed by the second application 122, when the primary card holder 102 submits the second account identifier of the second digital account that is created on the second application 122 as the information of the beneficiary, without deviating from the scope of the invention.

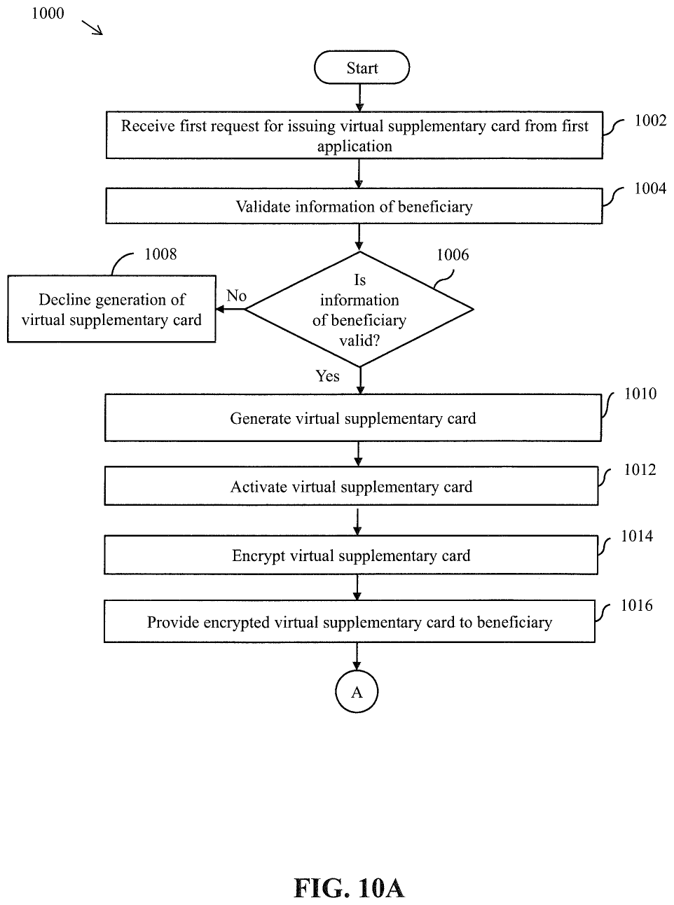

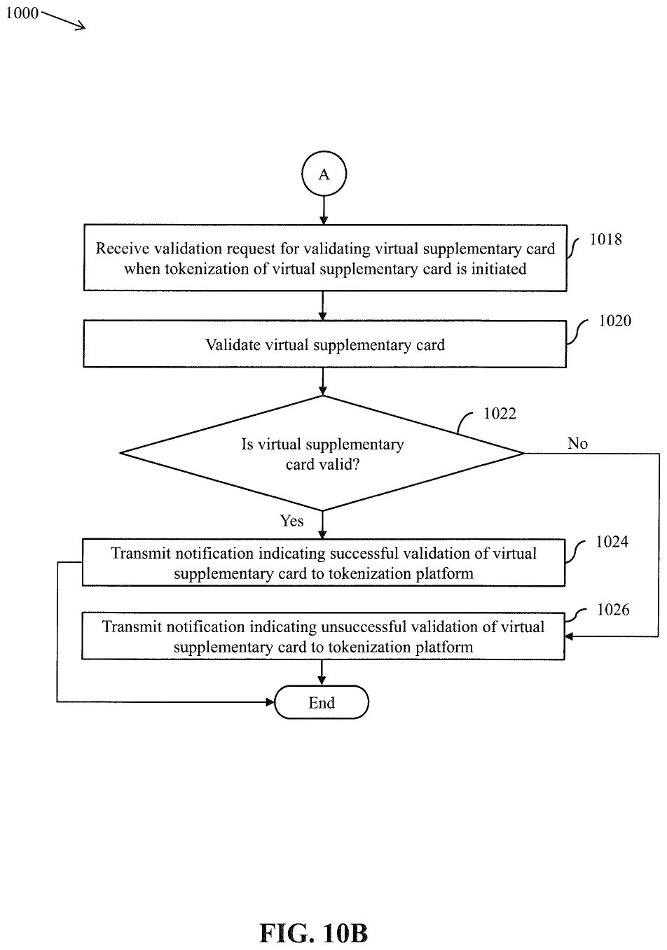

FIGS. 10A and 10B, collectively represent a flow chart 1000 that illustrates a method for issuing the virtual supplementary card to the beneficiary, in accordance with an embodiment of the present invention. The primary card holder 102 accesses the first digital account created on the first application 120 and selects the “request for supplementary card” button 812c (i.e., the third option) to request for issuing a virtual supplementary card linked to the primary card 104 to the beneficiary (i.e., the second user 108).

At step 1002, the issuer server 116 receives the first request for issuing the virtual supplementary card to the second user 108. The first request is initiated by the primary card holder 102 by selecting the third option and submitting the information of the second user 108 as the beneficiary. The first request includes the information of the second user 108. At step 1004, the issuer server 116 validates the information of the second user 108 (i.e., the beneficiary). At step 1006, the issuer server 116 determines whether the information of the second user 108 (i.e., the beneficiary) is valid. If at step 1006, it is determined that the information of the second user 108 (i.e., the beneficiary) is not valid, step 1008 is performed. At step 1008, the issuer server 116 declines the generation of the virtual supplementary card. Further, the issuer server 116 notifies the primary card holder 102 that the generation of the virtual supplementary card is declined. If at step 1006, it is determined that the information of the second user 108 (i.e., the beneficiary) is valid, step 1010 is performed.

At step 1010, the issuer server 116 generates the virtual supplementary card. The issuer server 116 links the generated virtual supplementary card to the primary card 104. At step 1012, the issuer server 116 activates the virtual supplementary card. Further, the issuer server 116 communicates the third notification to the primary card holder 102 to indicate that the virtual supplementary card is successfully generated. At step 1014, the issuer server 116 encrypts the generated virtual supplementary card based on the information (i.e., the third account identifier) of the second user 108 (i.e., the beneficiary). At step 1016, the issuer server 116 provides the encrypted virtual supplementary card to the first application 120 as the third digital account linked to the third account identifier is created on the first application 120. The encrypted virtual supplementary card is then added to the third digital account of the second user 108. In another embodiment, the issuer server 116 may provide the encrypted virtual supplementary card to the second application 122 when the primary card holder 102 provides the second account identifier as the information of the beneficiary.

When the encrypted virtual supplementary card is added to the third digital account, the first application 120 triggers and communicates the tokenization request to the tokenization platform 124 for tokenizing the encrypted virtual supplementary card. In response to the tokenization request, the tokenization platform 124 decrypts the encrypted virtual supplementary card and communicates the validation request to the issuer server 116 for the validation of the virtual supplementary card.

At step 1018, the issuer server 116 receives the validation request from the tokenization platform 124 for validating the virtual supplementary card, when the tokenization of the virtual supplementary card is initiated. At step 1020, the issuer server 116 validates the virtual supplementary card. At step 1022, the issuer server 116 determines whether the virtual supplementary card is valid. If at step 1022, it is determined that the virtual supplementary card is valid, step 1024 is performed.

At step 1024, the issuer server 116 communicates the notification indicating successful validation of the virtual supplementary card to the tokenization platform 124. Based on the notification, the payment network server 114 creates and transmits the token for the virtual supplementary card to the second user 108. The second user 108 uses the token for performing the transactions through the virtual supplementary card. If at step 1022, it is determined that the virtual supplementary card is invalid, step 1026 is performed. At step 1026, the issuer server 116 communicates the notification indicating unsuccessful validation of the virtual supplementary card to the tokenization platform 124. Based on the notification, the payment network server 114 suspends the tokenization of the virtual supplementary card and notifies the first application 120.

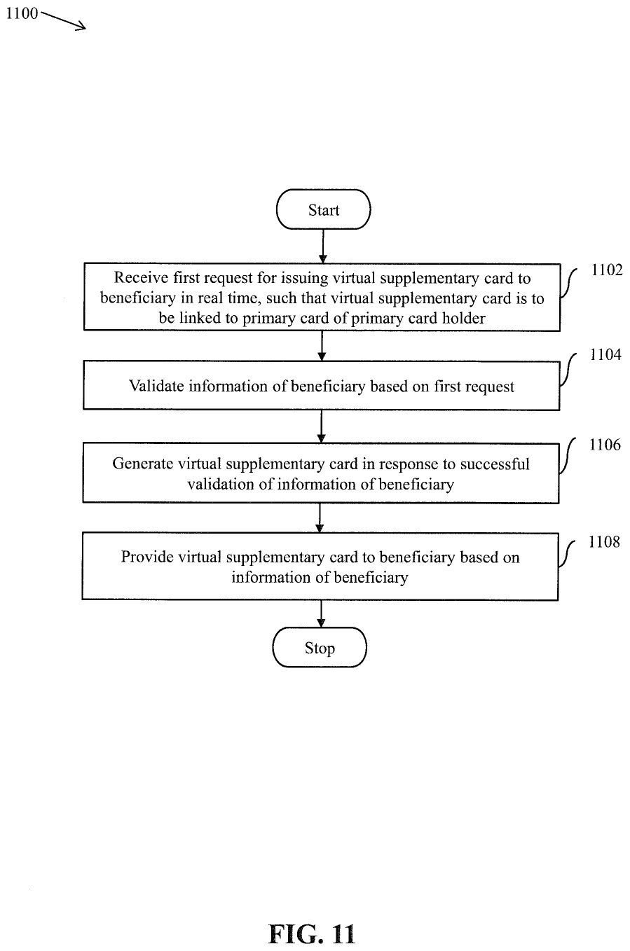

FIG. 11 represents a high-level flow chart 1100 that illustrates a method for issuing a supplementary card, in accordance with an embodiment of the present invention. At step 1102, a server (such as the issuer server 116) receives the first request for issuing the virtual supplementary card to a beneficiary (such as the second user 108) in real time. The virtual supplementary card is to be linked to the primary card 104 of the primary card holder 102. The first request includes the information of the beneficiary and is initiated by the primary card holder 102 from the first digital account created on the first application 120. At step 1104, the server (such as the issuer server 116) validates the information of the beneficiary. At step 1106, the server (such as the issuer server 116) generates the virtual supplementary card in real time in response to the successful validation of the information of the beneficiary. At step 1108, the server (such as the issuer server 116) provides the virtual supplementary card in real time to the beneficiary based on the information of the beneficiary. The virtual supplementary card is accessible to the beneficiary by way of the second digital account (or the third digital account) for performing the transactions.

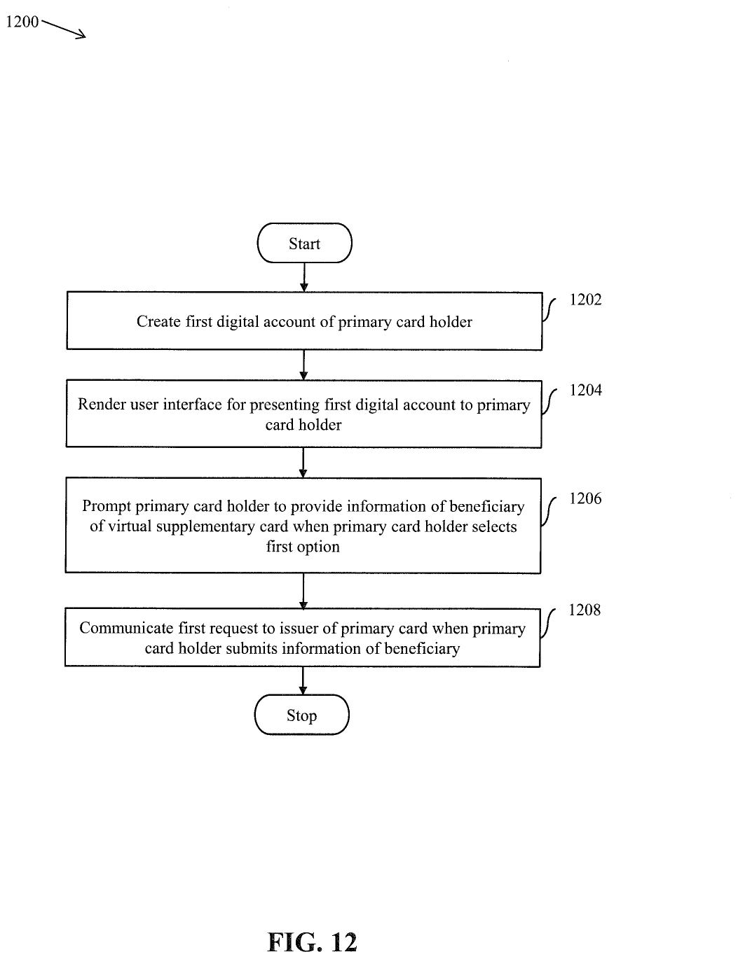

FIG. 12 represents a high-level flow chart 1200 that illustrates a method for procuring a supplementary card, in accordance with an embodiment of the present invention. At step 1202, the first application 120 hosted by the first application server 112a creates the first digital account of the primary card holder 102. At step 1204, the first application 120 renders the UI 802 that presents the first digital account to the primary card holder 102. The UI 802 includes the third option (i.e., the “request for supplementary card” button 812c) for issuing the virtual supplementary card linked to the primary card 104 in real time. At step 1206, the first application 120 prompts the primary card holder 102 to provide information of the beneficiary of the virtual supplementary card when the primary card holder 102 selects the third option. At step 1208, the first application 120 communicates the first request to the issuer of the primary card 104 when the primary card holder 102 submits the information of the beneficiary. The issuer server 116 generates the virtual supplementary card and provides the virtual supplementary card to the beneficiary in real time based on the first request. The virtual supplementary card is accessible to the beneficiary by way of the second digital account (or the third digital account) for performing the transactions.

Thus, the method and system of the present invention offer advantages to both the primary card holder 102 and the beneficiary (such as the second user 108). Firstly, the activated virtual supplementary card is provided to the beneficiary instantly after the primary card holder 102 raises the first request. In addition, the virtual supplementary card is automatically added to the digital account of the beneficiary without requiring any manual intervention of the beneficiary. Since, the issuer (such as the issuer server 116) issues and activates the virtual supplementary card in real time, the beneficiary can perform the transactions instantly when she receives the virtual supplementary card. Secondly, the tokenization of the virtual supplementary card adds an extra layer of security while performing the transactions. Since the token, which is a random alpha numeric character, is transmitted during the transactions, the information of the virtual supplementary card is secure. The token is associated with a two-factor authentication. The first authentication factor includes an association between the digital account of the beneficiary and the token. Thus, if the token is used on any other digital account, the token is rendered invalid. The second authentication factor includes a log-in password, a PIN number, a fingerprint of the beneficiary, a one-time password, or the like required for accessing the digital account of the beneficiary. Since the log-in password, the PIN number, the fingerprint of the beneficiary, or the one-time password is unique and only known to the beneficiary, the token remains secure.

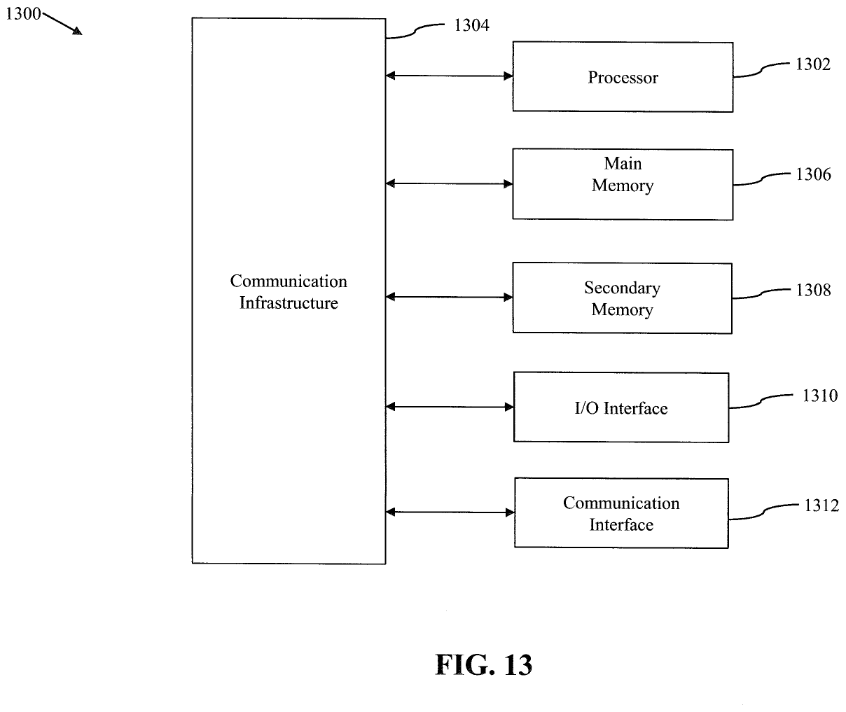

FIG. 13 is a block diagram that illustrates system architecture of a computer system 1300, in accordance with an embodiment of the present invention. An embodiment of present invention, or portions thereof, may be implemented as computer readable code on the computer system 1300. In one example, the first and second devices 106 and 110, respectively, the first application server 112a, the second application server 112b, the payment network server 114, and the issuer server 116 of FIG. 1 may be implemented in the computer system 1300 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 9, 10A, 10B, 11, and 12.

The computer system 1300 includes a processor 1302 that may be a special-purpose or a general-purpose processing device. The processor 1302 may be a single processor, multiple processors, or combinations thereof. The processor 1302 may have one or more processor cores. In one example, the processor 1302 is an octa-core processor. Further, the processor 1302 may be connected to a communication infrastructure 1304, such as a bus, message queue, multi-core message-passing scheme, and the like. The computer system 1300 may further include a main memory 1306 and a secondary memory 1308. Examples of the main memory 1306 may include RAM, ROM, and the like. In one embodiment, the main memory 1306 is one of the first memory 504, the second memory 604, or the third memory 704. The secondary memory 1308 may include a hard disc drive or a removable storage drive, such as a floppy disc drive, a magnetic tape drive, a compact disc, an optical disc drive, a flash memory, and the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1300 further includes an input/output (I/O) interface 1310 and a communication interface 1312. The I/O interface 1310 includes various input and output devices that are configured to communicate with the processor 1302. Examples of the input devices may include a keyboard, a mouse, a joystick, a touchscreen, a microphone, and the like. Examples of the output devices may include a display screen, a speaker, headphones, and the like. The communication interface 1312 may be configured to allow data to be transferred between the computer system 1300 and various devices that are communicatively coupled to the computer system 1300. Examples of the communication interface 1312 may include a modem, a network interface, i.e., an Ethernet card, a communication port, and the like. Data transferred via the communication interface 1312 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 1300. Examples of the communication channel may include, but are not limited to, cable, fiber optics, a phone line, a cellular phone link, a radio frequency link, and the like.

Computer program medium and computer usable medium may refer to memories, such as the main memory 1306 and the secondary memory 1308, which may be a semiconductor memory such as a DRAM. These computer program mediums may provide data that enables the computer system 1300 to implement the methods illustrated in FIGS. 9, 10A, 10B, 11, and 12. In an embodiment, the present invention is implemented using a computer implemented application, the computer implemented application may be stored in a computer program product and loaded into the computer system 1300 using the removable storage drive or the hard disc drive in the secondary memory 1308, the I/O interface 1310, or the communication interface 1312.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded in virtually any device. For instance, at least one processor such as the processor 1302 and a memory such as the main memory 1306 and the secondary memory 1308 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present invention provide, among other features, systems and methods for issuing supplementary cards. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A method for issuing supplementary cards, the method comprising:
receiving, by a server, a first request for issuing a virtual supplementary card in real time to a beneficiary, such that the virtual supplementary card is to be linked to a primary card of a primary card holder, wherein the first request includes information of the beneficiary and is initiated by the primary card holder from a first digital account created on a first application;
validating, by the server, the information of the beneficiary based on the first request;
generating, by the server in real time, the virtual supplementary card in response to a successful validation of the information of the beneficiary; and
providing, by the server in real time, the virtual supplementary card to the beneficiary based on the information of the beneficiary, wherein the virtual supplementary card is accessible to the beneficiary by way of a second digital account for performing one or more transactions.

2. The method of claim 1, wherein the information of the beneficiary includes an identifier of the second digital account, a name of the beneficiary, and a contact number linked to the second digital account.

3. The method of claim 2, further comprising encrypting based on the identifier of the second digital account, by the server, the virtual supplementary card prior to providing the virtual supplementary card to the beneficiary.

4. The method of claim 1, further comprising activating, by the server, the virtual supplementary card prior to providing the virtual supplementary card to the beneficiary.

5. The method of claim 1, wherein the second digital account is created by the beneficiary on one of the first application or a second application that is different from the first application, and wherein one of the first application or the second application that is associated with the second digital account receives the virtual supplementary card from the server and communicates a second request to a tokenization platform for tokenizing the virtual supplementary card.

6. The method of claim 5, further comprising receiving, by the server from the tokenization platform, a validation request for validating the virtual supplementary card, wherein the tokenization platform tokenizes the virtual supplementary card when the virtual supplementary card is validated by the server and communicates a token for the virtual supplementary card to the beneficiary, and wherein the token is accessible to the beneficiary by way of the second digital account for performing the one or more transactions.

7. A system for issuing a supplementary card, the system comprising:
an issuer server that is configured to:
receive a first request for issuing a virtual supplementary card in real time to a beneficiary, such that the virtual supplementary card is to be linked to a primary card of a primary card holder, wherein the first request includes information of the beneficiary and is initiated by the primary card holder from a first digital account created on a first application;
validate the information of the beneficiary based on the first request;
generate the virtual supplementary card in real time, in response to a successful validation of the information of the beneficiary; and
provide the virtual supplementary card to the beneficiary in real time based on the information of the beneficiary, wherein the virtual supplementary card is accessible to the beneficiary by way of a second digital account for performing one or more transactions.

8. The system of claim 7, wherein the information of the beneficiary includes an identifier of the second digital account, a name of the beneficiary, and a contact number linked to the second digital account.

9. The system of claim 8, wherein the issuer server is further configured to encrypt, based on the identifier of the second digital account, the virtual supplementary card prior to providing the virtual supplementary card to the beneficiary.

10. The system of claim 7, wherein the issuer server is further configured to activate the virtual supplementary card prior to providing the virtual supplementary card to the beneficiary.

11. The system of claim 7, wherein the second digital account is created by the beneficiary on one of the first application or a second application that is different from the first application, and wherein one of the first application or the second application that is associated with the second digital account receives the virtual supplementary card from the issuer server and communicates a second request to a tokenization platform for tokenizing the virtual supplementary card.

12. The system of claim 11, wherein the issuer server is further configured to receive, from the tokenization platform, a validation request for validating the virtual supplementary card, wherein the tokenization platform tokenizes the virtual supplementary card when the virtual supplementary card is validated by the issuer server and communicates a token for the virtual supplementary card to the beneficiary, and wherein the token is accessible to the beneficiary by way of the second digital account for performing the one or more transactions.

13. A method for procuring a supplementary card, the method comprising:
creating, by a first application hosted by a server, a first digital account of a primary card holder;
rendering, by the first application, a user interface for presenting the first digital account to the primary card holder, wherein the user interface includes a first option for issuing a virtual supplementary card linked to a primary card of the primary card holder in real time;
prompting, by the first application, the primary card holder to provide information of a beneficiary of the virtual supplementary card when the primary card holder selects the first option; and
communicating, by the first application, a first request to an issuer of the primary card when the primary card holder submits the information of the beneficiary, wherein the issuer generates the virtual supplementary card and provides the virtual supplementary card to the beneficiary in real time based on the first request, and wherein the virtual supplementary card is accessible to the beneficiary by way of a second digital account for performing one or more transactions.

14. The method of claim 13, wherein the first request includes an identifier of the second digital account, a name of the beneficiary, and a contact number linked to the second digital account.

15. The method of claim 13, wherein the virtual supplementary card is encrypted and active for performing the one or more transactions when the beneficiary receives the virtual supplementary card in the second digital account.

16. The method of claim 13, wherein the second digital account is created by the beneficiary on the first application.

17. The method of claim 16, further comprising:
receiving, by the first application, the virtual supplementary card from the issuer;
adding, by the first application, the virtual supplementary card to the second digital account of the beneficiary; and
communicating, by the first application, a second request to a tokenization platform for tokenizing the virtual supplementary card when the virtual supplementary card is added to the second digital account.

18. The method of claim 17, wherein the second request includes the virtual supplementary card in an encrypted format.

19. The method of claim 17, further comprising receiving, by the first application, a token for the virtual supplementary card from the tokenization platform.

20. The method of claim 19, further comprising adding, by the first application, the token to the second digital account, wherein the token is accessible to the beneficiary by way of the second digital account for performing the one or more transactions.
